(19) United States
(12) Patent Application Publication
(10) Pub. No.: US 2009/0199178 A1
(43) Pub. Date: Aug. 6, 2009

(54) Virtual Application Management

(75) Inventors: Bryan Keller, Snoqualmie, WA (US); Kenneth W. Revels, Woodinville, WA (US); Daniel Drew, Aliso Viejo, CA (US); Khuzaima Iqbal, Issaquah, WA (US); Alan C. Shi, Redmond, WA (US); Neil Jacobson, Arlington, MA (US); Eric Jewart, Waltham, MA (US); Gene Ferioli, Amesbury, MA (US); John Sheehan, Somerville, MA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/024,112

(22) Filed: Feb. 1, 2008

(51) Int. Cl. G06F 9/455

(52) U.S. Cl. 718/1

(57) ABSTRACT

A management system for virtual applications may deploy sets of virtual applications to many client devices by defining and distributing policies. The polices may define which client devices and/or users may permitted to access a virtual application from a server and how the virtual application may be used. A client device may include a virtual application management client that may communicate with a management server to retrieve and implement the policies. The management client may add or remove virtual applications to the client device based on a policy received from the management server. In some embodiments, policies may also be distributed and implemented on a virtual application server.

### BACKGROUND

Virtual applications are computer programs that may be executed in an application layer that is separate from the operating system layer. Virtual applications may enable an application to be executed on clients without being installed and to be administered from a central location.

Every application depends on its OS for a range of services, including memory allocation, device drivers, and much more. Incompatibilities between an application and its operating system can be addressed by either server virtualization or presentation virtualization. Application virtualization may address incompatibilities between two applications installed on the same instance of an operating system.

Applications installed on the same device commonly share configuration elements, yet this sharing can be problematic. For example, one application might require a specific version of a dynamic link library (DLL) to function, while another application on that system might require a different version of the same DLL. Installing both applications creates a situation where one of the applications may overwrite the version required by the other causing one of the applications to malfunction or crash. To avoid this, organizations often perform extensive compatibility testing before installing a new application, an approach that's workable but quite time-consuming and expensive.

Application virtualization may create application-specific copies of all shared resources. Each application may have a separate configuration of potentially shared resources such as registry entries, dynamic linked libraries, and other objects that may be packaged with the application. The package may be executed in a cache, creating a virtual application. When a virtual application is deployed, it uses its own copy of these shared resources.

A virtual application may be more easily deployed. Since a virtual application does not compete for dynamic linked library versions or other shared aspects of an application environment, compatibility testing may be reduced or eliminated. In many instances, some applications may be used in a virtual manner while other applications may be operated natively.

### SUMMARY

A management system for virtual applications may deploy sets of virtual applications to many client devices by defining and distributing policies. The polices may define which client devices and/or users may permitted to access a virtual application from a server and how the virtual application may be used. A client device may include a virtual application management client that may communicate with a management server to retrieve and implement the policies. The management client may add or remove virtual applications to the client device based on a policy received from the management server. In some embodiments, policies may also be distributed and implemented on a virtual application server.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a policy driven virtual application management system.

FIG. 2 is a diagram illustration of an embodiment showing a functional representation of a policy driven virtual application management system.

FIG. 3 is a flowchart diagram of an embodiment showing a method for installing and maintaining policies on a client.

FIG. 4 is a flowchart diagram of an embodiment showing a method for creating and distributing policies.

### DETAILED DESCRIPTION

A virtual application management system may provide various management functions to assist in deploying virtual applications across an enterprise. In many embodiments, a virtual application management system may comprise a central management server and several virtual application servers that may each serve many client devices. One application may be a company with many client devices that may access the virtual applications.

The architecture of a management system may use policies to add, remove, and configure virtual applications on a client device. The policies may be defined for individual devices, individual users, or collections of devices or users. The management server may define and distribute the policies across an organization. The policies may be used by a client management application to add and remove icons, menu selections, or other user interface components based on the presence or absence of virtual applications defined in the policy. In some embodiments, the policies may be distributed to the client devices and/or virtual application servers.

By issuing policies from a centralized location, the configuration of many client devices may be managed in a simple manner. When a policy is received by a client, the available virtual applications may be changed from one set of virtual applications to another, effectively reconfiguring the client device for a user.

In a typical deployment, a centralized management server may be used to create and distribute policies to individual clients. Each client device may have one or more policies that are used by a client management application on the client device to configure the user interface and direct requests for various virtual applications to the appropriate virtual application server. Other deployments may distribute policies to virtual application servers to achieve some or all of the effects of the policies.

In some embodiments, the management server may create policies that may be distributed to the virtual application servers. Such policies may establish which devices or users may be authorized to access specific virtual applications on each server, or may enable, disable, or configure the virtual applications delivered by each server.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

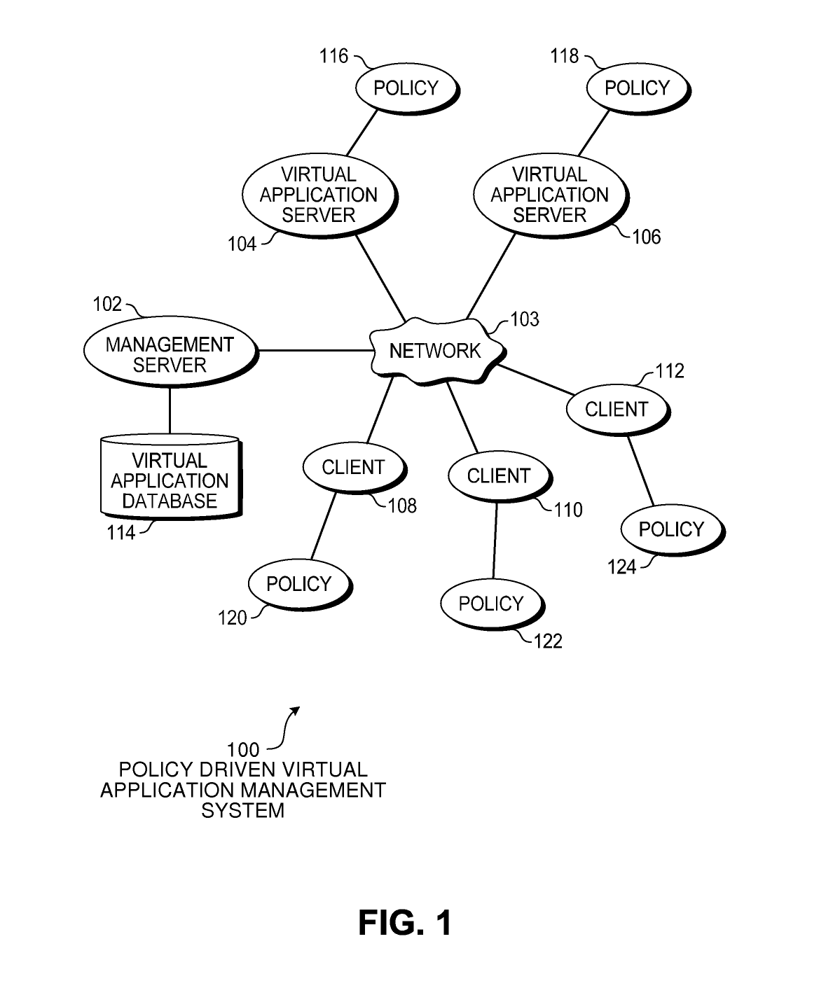

FIG. 1 is a diagram of an embodiment 100 showing a system with managed virtual applications. Embodiment 100 is a simplified example of a virtual application management system that may manage virtual applications across many client devices.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is a simplified example of a policy driven management system that may be capable of adding, removing, and configuring one or more virtual applications on several client devices. In a typical deployment, a management system may be used to manage the virtual applications across many client devices. A deployment man manage be tens, hundreds, or even thousands of devices within an organization such as a department, company, or other enterprise.

Virtual applications have several capabilities that differentiate virtual applications from conventional applications. Virtual applications may be ‘packaged’ with registries, dynamic linked libraries (DLLs), and other components of an application. The virtual application may be executed in a manner that does not interfere with other applications, services, or executables on a client device. Virtual applications may be executed in a virtual environment that separates the application layer from the operating system layer in a computing platform.

In a conventional or non-virtual application, many components such as registry entries, DLLs, and other components are installed within other similar components in an operating system. An example of a problem may occur when two applications share the same DLL, but one application gets upgraded and may expect one version of the DLL while the other application may operate with an older version of the same DLL.

Because conventional applications interface with operating system components, conventional applications generally undergo a complex install and uninstall process. In cases where an application has a shared component such as a shared DLL, an uninstall process may leave the DLL so as not to cause a problem with another application.

Virtual applications may generally be added and removed without a complex install or uninstall process. Virtual applications may be added or removed by adding or removing the unitized virtual application package from a client device.

Virtual applications may be supplied from a server in different forms. In one type of deployment, a virtual application may be streamed from a virtual application server. In a streaming deployment, a client may request a virtual application from a virtual application server which may begin transmitting portions of the virtual application that may be executed directly. A streaming virtual application may begin execution on the client device with a portion of the executable instructions and, in some cases, without having the entire virtual application downloaded to the client. Streaming techniques may enable a virtual application to start execution quickly. In many such deployments where there is available network bandwidth and a responsive virtual application server, a user experience may rival a locally stored and executed application.

Some streaming deployments may enable an application to be executed on a client device by transferring executable instructions from a virtual application server to random access memory (RAM) on the client device without storing the executable instructions on a persistent storage device such as a hard disk.

Other deployments may use a local copy of a virtual application that may be stored on a hard disk or other storage device local to the client. The local copy of the virtual application may be downloaded from a virtual application server prior to use.

Some embodiments may use a combination of streaming technologies with a local copy of a virtual application. Such an embodiment may use various streaming techniques to begin downloading and executing a virtual application on a client device and may further store the downloaded virtual application on a local storage device for a second or subsequent use. Many such embodiments may enable a client device to being execution quickly with the initial portions of the download and may continue to download remaining portions of the virtual application as bandwidth permits so that the client device may eventually contain the entire virtual application locally. When the application is available locally, the application may sometimes execute faster.

Streaming deployments have a capability that may enable an application to be upgraded on the virtual application server without having to upgrade or change the client device. Such a capability may ease licensing, managing, monitoring, and other administrative tasks.

Embodiment 100 illustrates a policy driven virtual application management system. The system may comprise a management server 102 that may be a central point from where the configuration of various devices may be managed. The devices include virtual application servers 104 and 106 and client devices 108,110, and 112.

The management server 102 may be capable of generating and distributing policies 116 and 118 to virtual application servers 104 and 106, respectively, as well as policies 120,122, and 124 to clients 108, 110, and 112, respectively. The various policies may be used by the respective clients or servers to affect the availability and performance characteristics of virtual applications executed by the clients.

The policies may define which virtual applications may be available in certain situations. In some embodiments, a client management application may receive a policy and configure user interfaces and other client components so that a virtual application may be accessed and executed. The client management application may be an application that runs continuously or periodically and may effectively add, remove, or configure virtual applications on the client.

When a policy is received by a client device, the policy may define which virtual applications, if any, are to be made available on the client device. The policy may cause the user interface of the client device to change by adding or removing icons, menu items, or other user interface mechanisms that may cause the virtual application to be launched. The policy may further enable virtual applications to be configured so that other applications or services may cause the virtual application to be executed.

One mechanism for implementing the changes defined in a policy is through a client management application. Some embodiments may have a similar functionality embodied in other applications, services, or components on the device or may implement policy changes using different mechanisms. For the purposes of illustration, a client management application may be described in this specification merely to illustrate various functional concepts and not to limit the described functions to a specific architecture.

The policies may be used to configure a client to access a virtual application. The policy may define a virtual application, the conditions for using the virtual application, and any parameters that may be defined for the execution of the virtual application. In many embodiments, the policy may cause an icon, menu item, or other user interface component to be presented for a user to select. Some embodiments may provide a link, address, variable, or other mechanism so that another application may call the virtual application.

The policy may be used to define conditions for the use of the virtual application. For example, a policy may define the device or devices that are permitted to access a virtual application. In some cases, the policies may define the users that are permitted to use or operate a virtual application.

When a virtual application is defined in a device-based policy, the application may be executed on the device, regardless of the user of the device. In a user-based policy, a specific user or set of users may be allowed to access a virtual application while other users of the device may not. In a user-based policy, many devices may use identical policies, thereby allowing a user to switch devices and still have the same set of virtual applications available.

The policy may define parameters for the execution of the virtual application. In some embodiments, an option in the policy may define whether a virtual application may be operated in a streaming fashion with little or no local storage of the virtual application. In other embodiments, a policy option may enable a virtual application to be downloaded and stored locally. Some policies may define other operational or metadata information that may be used to define the execution behavior of the virtual application. For example, some policies may define an address or group of addresses for a virtual application server for each virtual application.

A policy may be received by a client through the actions of a client management application or some other service or application that may periodically query a management server to request any updated policies. For example, a function on a client device may send out an hourly or daily query to the management server 102 to determine if an updated policy is available. If a policy is available, the policy may be transmitted to the client. Such a function may be a pull-type architecture where the recipient of a policy may poll the management server 102. Another example of a pull-type architecture may be for a client to check a location or file on a network file system and copy the policy to a local storage.

In other embodiments, a push-type architecture may be employed. In a push-type architecture, the management server 102 may send the policy to a recipient by a messaging service, by placing a policy file in a file system that may be accessed by the policy, or through some other affirmative action. In a push-type architecture, the management server 102 may initiate a communication sequence for transferring the policy. Still other embodiments may use other architectures, queries, transmission protocols, or other mechanisms to distribute and transport policies to the various clients.

Some embodiments may use a common policy that is shared across many or all of the various clients or other recipients. Other embodiments may define individual policies that are custom to each device or user. When a common policy is used across many devices, the policy may have an identifier for a specific device or user and the virtual applications that may be accessed by that device or user. The identifier may distinguish a portion of the policy that may be applied to a specific device or user.

In other embodiments, individual policies may be created for each user or device. In such an embodiment, each policy may be different from another policy and may be intended to configure one device. Such policies may include identifiers for the device or user, such as the network address, media access control (MAC) address, processor serial number, or other identifier for the device. User specific policies may include login credentials, pass phrases, or other user identification.

Policies 116 and 118 may be created and deployed for virtual application servers 104 and 106. In some embodiments, the polices 116 and 118 may serve to permit or deny various virtual applications to client devices or users. For example, the policies 116 and 118 may contain a list of virtual applications that are able to be accessed by each user. When a user attempts to access a virtual application that is not permitted by the policies 116 and 118, the user may be denied.

The server policies 116 and 118 may include similar information as the policies described above for the clients, and in some cases may cause similar effects. For example, a client 108 may connect to a virtual application server 104 and the policy 116 may cause various virtual applications to be made available on a user interface attached to the client 108. If the policy 116 is changed to reflect a different set of permitted virtual applications, the user interface on the client 108 may change to reflect the currently permitted virtual applications.

Some embodiments may use a policy on client devices, where the policy on the client may cause virtual applications to be available and configured at each client. Other embodiments may use a policy on the server to perform a similar function.

In some embodiments, policies may be installed on both the clients and servers. In such embodiments, a portion of the policy may reside on the client, such as the available virtual applications, and other portions of the policy may reside on the server, such as the manner in which a virtual application is to be used.

The management server 102 may have a virtual application database 114 that may be used by an administrator to create the various policies. The virtual application database 114 may include an inventory of available virtual applications, current allocations of virtual applications across the clients, user profiles, device and server configurations, or any other information that may be used in creating and distributing profiles. In some cases, the management server 102 may include various automated discovery mechanisms, data collection mechanisms, or other functions that may keep the virtual application database 114 up to date.

In one use scenario, a client device may be transferred from one department to another department in a company. If the first department was, for example, a software development department, the client device may have a suite of software development tools assigned as virtual applications. The client device may be reconfigured for an administrative assistant in a marketing department by changing the policy that may remove the software development tools and add word processor applications, marketing database applications, and other applications to the client. The reconfiguration and redeployment of the client device may be accomplished through a policy change without complex removal of one group of applications and installation of a second group of applications.

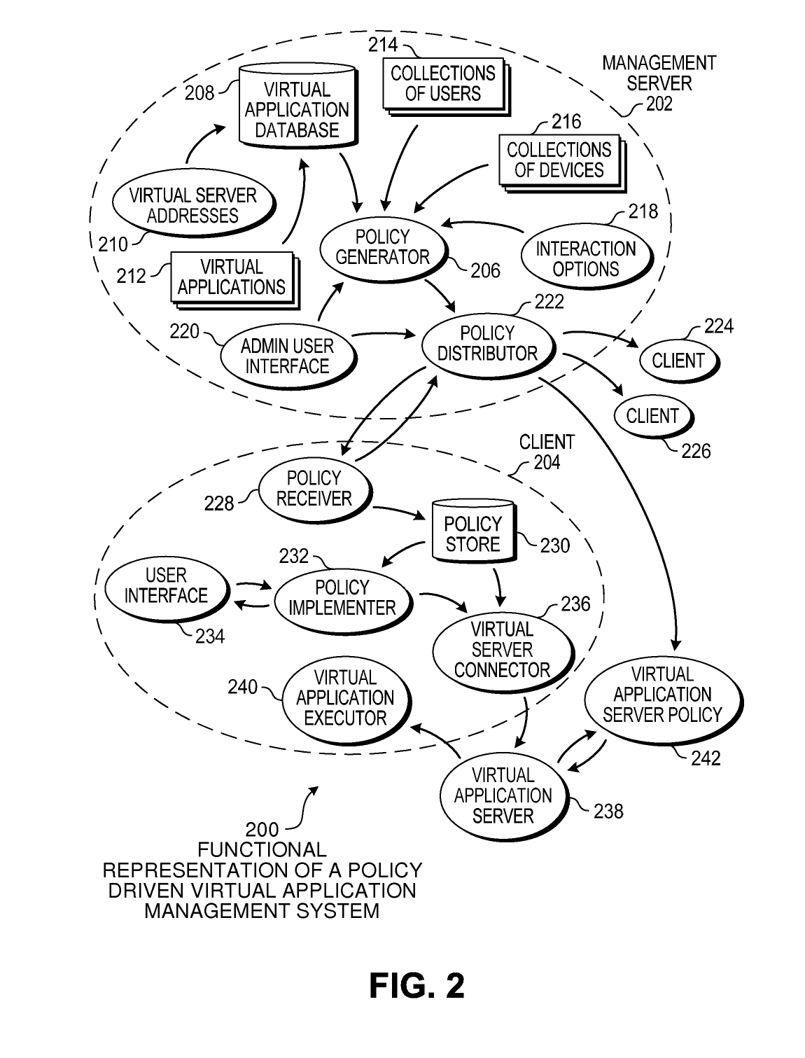

FIG. 2 is a functional diagram illustration of an embodiment 200 that is an example of a functional representation of a policy driven virtual application management system. Embodiment 200 illustrates the functional components that may make up an embodiment that uses policies to control the use and distribution of virtual applications. Embodiment 200 illustrates a policy mechanism that may be in place on a client device. Other embodiments may have similar functionality that may be implemented wholly or in part by a policy on a virtual application server.

The diagram of FIG. 2 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a management server 202 and a client 204. The management server 202 may be analogous to the management server 102 of FIG. 1, and the client 204 may be analogous to one of the clients 108, 110, or 112 of FIG. 1.

The management server 202 may be used to create and distribute policies to clients and, in some cases, virtual application servers. For the purposes of illustration, the functional components that are affected by policies are illustrated as client-only policies in embodiment 200.

The management server 202 may be used to create policies using an administrative user interface 220. An administrative user interface 220 may be a web interface, console interface, scripting interface, or other input mechanism whereby an administrator may create, define, modify, edit, distribute, or otherwise manipulate policies. Various embodiments may have different user interface configurations and user interface tools or mechanisms for receiving commands and causing policies to be constructed and distributed.

A policy may be generated using a policy generator 206 that may take various input parameters and create a policy that may be used by a client or server. The virtual application database 208 may include virtual server addresses 210 and virtual applications 212 from which an administrator may pick and choose. Groups or collections of users 214 and devices 216 may also be included in a policy, as well as interaction options 218 or other parameters.

Various embodiments may have different techniques, syntaxes, protocols, and methods for defining a policy. In general, a policy may contain references to one or more virtual applications. A reference may be a command or address used to begin execution of a virtual application or some other reference. In many cases, various parameters may be used to define how a virtual application may be executed or other parameters associated with the virtual application. For example, in some cases an image of an icon for the virtual application may be included in the policy.

The virtual applications may be assigned to specific users or devices. In some cases, such assignments may be defined within the policy, while in other cases, the assignments may be made by distributing the policies to the appropriate devices or associated with a user.

When the specific devices may be included in the policy, an identifier for a device may include various hardware or network identifiers, addresses, or other identifiers. In some cases, a device may be identified by a membership in a group or collection of devices or by a range of addresses or other type of identification.

When specific users may be included in a policy, a user name, login identification, or other identifier may be used to identify a user. In some cases, groups of users may be identified by identifying the group or range of users. In some embodiments, a policy may define both a device and a user within a policy.

A policy may include various interaction options 218 or other parameters that may define how a virtual application is accessed, transferred to a client, and executed. Such parameters may include an indicator if the virtual application is to be accessed using a streaming mechanism or if the virtual application is to be downloaded and stored. In some cases, some interaction options 218 may include limitations on features or capabilities of a virtual application, or may enable or disable various functions of the virtual applications. Some interaction options 218 may include rules or other complex descriptions in addition to declarative statements.

In some instances, a policy may include various data, executables, scripts, images, or other components that may be used by a client to change a user interface to allow a user to access the virtual application. For example, a policy may include an icon or other graphical item that may be placed on a graphical user interface. The policy may also include a script that may be executed when an icon or menu item is selected.

The policy distributor 222 may distribute the policies to various clients 204, 224, and 226. In some embodiments, policies may be distributed to virtual application servers 238 as a virtual application server policy 242, in addition to the clients or instead of the clients. In the example of embodiment 200, the policies are distributed to the clients.

In some embodiments, a policy may be defined for a specific client and may or may not include identifiers for the client. When client identifiers are not included in a policy, a client may act on whatever policy is present. In such an embodiment, the policy distributor 222 in conjunction with the policy generator 206 may determine which specific client a policy is intended and may route that policy to the intended client.

In other embodiments, a policy may include an identifier for a client. The identifier may be used by the policy distributor 222 to route the policy. Such an identifier may be within a policy definition such that a client that acts upon the policy may verify that it is indeed the intended recipient. In other cases, the identifier may be in metadata, a message header, or other format that may be used to route the policy to the intended recipient.

In some cases, a policy that is transmitted to a client may include multiple entries of policies used by several different clients. Within the policy definition, a client may find an identifier matching the client's identification and operate on a portion of the policy allocated for that client.

Various embodiments may have different methods, syntaxes, and techniques for describing available virtual applications, any options associated with the virtual applications, any criteria for allowing or disallowing access to one or more virtual applications, or other factors that may be incorporated into a policy.

The policy receiver 228 may perform some of the communication functions that may transfer the policy from the policy distributor 222 to the client 204. In some embodiments, the policy receiver 228 may pull the policy from the policy distributor 222. In such an embodiment, the policy receiver 228 may initiate communication to receive a policy. In some embodiments, the policy distributor 222 may initiate communication to push a policy to the client 204. In such an embodiment, the policy receiver 228 may respond to an initiation from the policy distributor 222. Many different communication protocols, methodologies, and techniques may be employed to transfer a new or updated policy from the management server 202 and the client 204.

When a policy is received by a policy receiver 228, the policy may be stored in a policy store 230. In many embodiments, the policy store 230 may be a local persistent storage device, such as a hard disk. In other embodiments, the policy may be stored across a network. In some cases, the policy may be stored in volatile memory such that the policy is lost when a device is powered down and may be received and used each time a device is started.

The policy implementer 232 may use the policy to make changes to the user interface 234 and enable a user or other application to access the virtual application. The policy implementer 232 may operate to create icons, menu items, or other user interface mechanisms through which a user may initiate a virtual application. In some cases, the policy implementer 232 may receive an input from a user or an application or service and initiate a virtual application. In other cases, a shortcut, script, or other mechanism may be used to initiate a virtual application without being handled or processed by the policy implementer 232.

When a virtual application is selected for execution by a user, application, or service, the virtual server connection 236 may use the input as well as the policy from the policy store 230 to initiate a virtual application session with a virtual application server 238. Various embodiments may use different mechanisms, protocols, and techniques to communicate with a virtual application server 238 and launch a virtual application.

In some embodiments, a virtual application may be executed by a virtual application executor 240 by streaming executable portions of the virtual application from the virtual application server 238 and executing the virtual application in a virtual environment.

In other embodiments, the virtual application may be downloaded to the client 204 from the virtual application server 238, stored in a local persistent or volatile storage, and executed using the virtual application executor 240. In some such embodiments, the virtual application may be downloaded at the first request for the virtual application, while second or subsequent requests may serve to launch the locally stored virtual application.

The virtual application executor 240 may be the function through which a virtual application may be executed in a virtual manner. In some embodiments, a virtual application may be operated in an environment that comprises various features or functions within an operating system to enable virtualized execution. In other embodiments, such features may be incorporated into the virtual application.

The database 208 may be any kind of repository for data. In some embodiments, the database 208 may be a relational database managed with a relational database system. In other embodiments, the database 208 may be an XML file, a tabular spreadsheet, a text file containing individual records, an array of data stored within an application, or any other instrument by which data may be stored on a temporary or persistent basis.

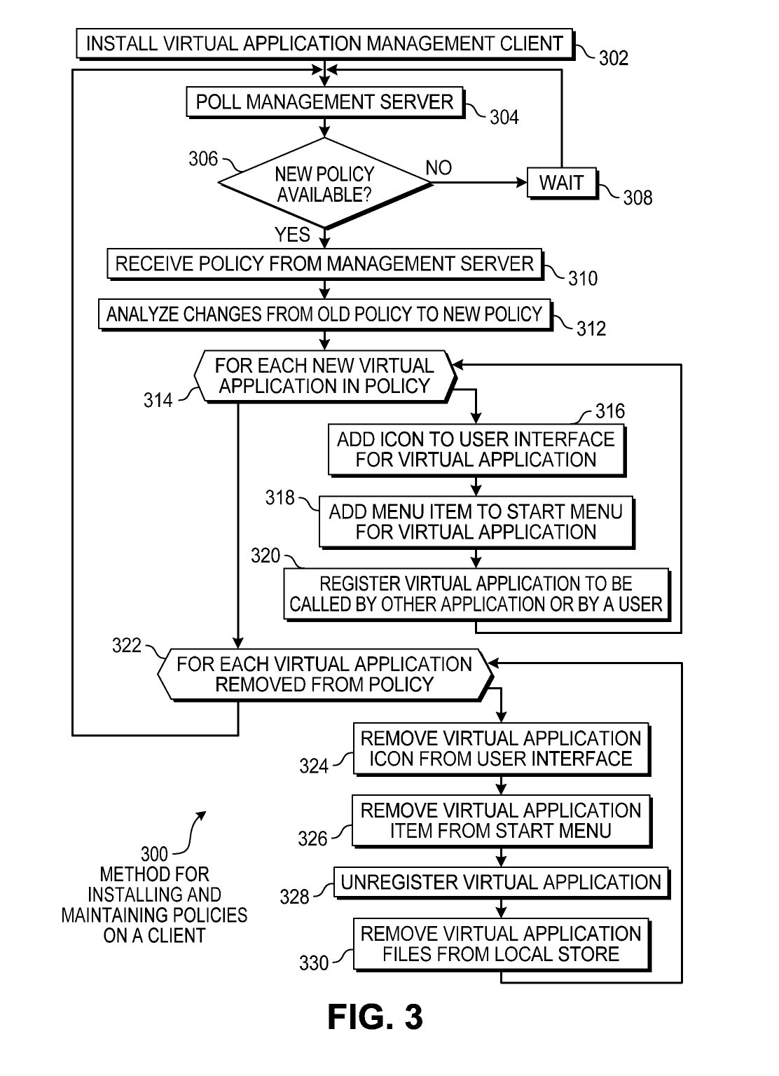

FIG. 3 is a flowchart illustration of an example embodiment 300 showing a method for maintaining policies on a client. Embodiment 300 is an example of a sequence of operations or functions that may be used by a client to retrieve a policy and make changes to a user interface based on the policy.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 may retrieve a policy using a pull-type interaction, compare the new policy to an existing policy, add new user interface components for newly added virtual applications, and remove other user interface components for those virtual applications that were removed. Embodiment 300 illustrates these functions as discrete steps and sequences. However, other embodiments may use different techniques or sequences to accomplish the same end result.

For example, a different embodiment may receive a new policy, remove any changes implemented by a previous policy, and create new user interface components based on the new policy. In instances where a virtual application was defined in both policies, the net effect may be that the user interface components for the virtual application are removed and replaced, and may be essentially unchanged. In instances where a virtual application is removed from one policy to the next, the virtual application is removed and not replaced. In instances where a virtual application is added in the new policy, the virtual application is simply added. Such an embodiment may have a different structure or architecture, but may create the same net results or perform the same functions as embodiment 300.

A virtual application management client may be installed in block 302. In some embodiments, a locally running application on a client device may perform some or all of the functions described in embodiment 300. Other embodiments may have different system architectures to perform essentially the same functions as described for the virtual application management client as described above.

The virtual application management client may act in a pull-type arrangement to pull updated policies from a management server. The management server may be polled in block 304, and if a new policy is not available in block 306, a waiting period may commence in block 308 before another poll may be performed in block 304. When a virtual application management client performs a poll in block 304, a request or other message may be transmitted to the management server to determine if an updated policy is available. Various embodiments may have different techniques, communication media, protocols, or mechanisms for accomplishing this function.

If a new policy is available in block 306, the policy is received from the management server in block 310.

After receiving the new policy in block 310, the differences between the old policy and the new policy are determined in block 312. The analysis of the differences may result in a group of virtual applications to be added and a group of virtual applications to be removed. If the new policy is the initial policy for the client, the new policy may contain virtual applications to be added. In some embodiments, a new policy may include descriptions or identifiers of virtual applications that are to be removed, while in embodiments such as embodiment 300, such information may be inferred or deduced by comparing the new and old policies.

For each new virtual application added in the new policy in block 314, the virtual application may be made available to a user or other application through blocks 316, 318, and 320.

In block 316, an icon may be added to a user interface. In block 318, a menu item may be added to a start menu. The virtual application may be registered in block 320 so that the virtual application may be called by a user or other application. In some operating systems or execution environments, a registration process may be used to indicate that an application or virtual application is available for execution.

In many embodiments, an icon or menu item may be accompanied by a script, command, address, or other information that may be used to launch the virtual application. In some cases, such information may be used to launch the virtual application directly, while in other cases, an intermediate application such as a virtual application management client or other application may process the request prior to launching the virtual application.

For each virtual application that is removed from the old policy to the new policy in block 322, the virtual application may be made unavailable through blocks 324, 326, 328, and 330.

In block 324, any icons associated with the removed virtual application may be removed from a user interface, and in block 326, any corresponding menu items may also be removed. The virtual application may be unregistered in block 328.

In block 330, any files relating to the removed virtual application may be removed from a local storage. In some embodiments, a virtual application may be downloaded completely or in part and locally stored. In such a case, the locally stored components may not be useful when access to the virtual application is removed and thus may be discarded.

Embodiment 300 may be used when a policy is implemented for a device or for a user. In a device-specific policy, a policy may be implemented for any user of a device. As such, modifications to a user interface may include modifying a portion of a user interface that is common to all users of the device. In a user-specific policy, each user of a device may have different virtual applications that are available to the user.

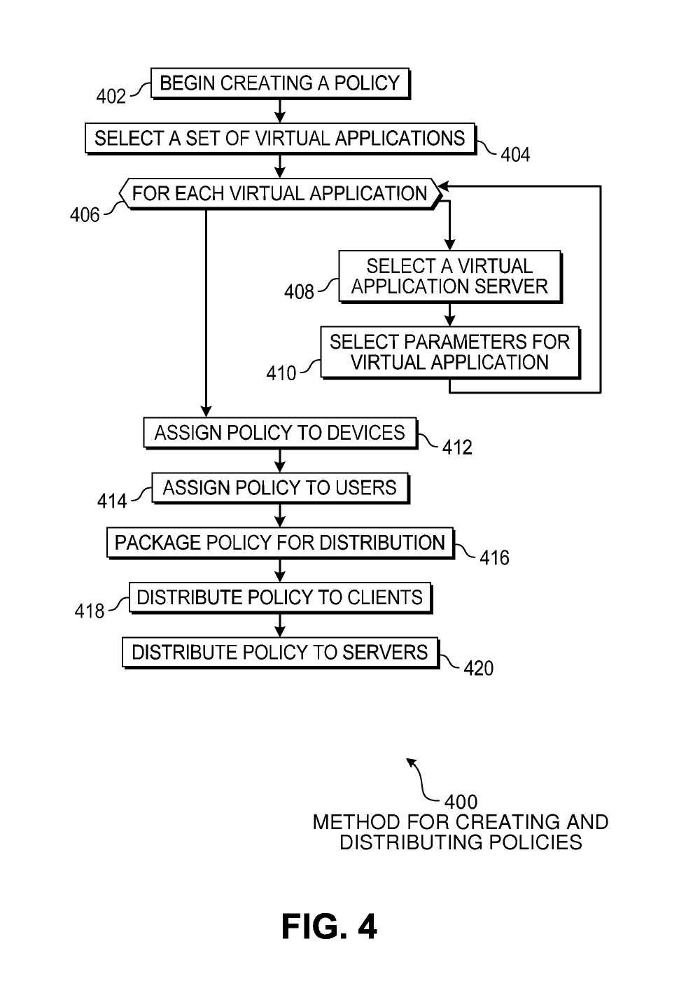

FIG. 4 is a flowchart illustration of an embodiment 400 showing a method for creating and distributing policies. Embodiment 400 is an example of a sequence of functions that may be performed by a management server.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example of the functions that may be performed automatically or with a user input to create and distribute a policy.

In block 402, the policy may begin to be created. In many embodiments, an administrator or other user may define a policy. In some embodiments, a graphical user interface may be used to define a policy using a wizard, progressive user interface, or some other mechanism. In some cases, an administrator may create a policy using a text editor and a scripting language, XML, or some other descriptors. Each embodiment may have different mechanisms by which a policy may be generated. In some cases, some of the steps described in the embodiment 400 may be fully or partially automated.

A set of virtual applications may be selected in block 404. In some cases, a single virtual application may be selected. In a case where a policy may be used to remove all virtual applications from access by a device or user, a policy may contain no virtual applications.

For those virtual applications selected in block 404, each virtual application may be configured in block 406. A virtual application server may be selected in block 408 and any parameters, options, or other configuration values may be selected in block 410. In some cases, a single virtual application may be selected for each virtual application, while in other cases a primary and secondary server may be selected. Some embodiments may use various mechanisms to connect to a virtual application server, and such mechanisms may be configured in block 408.

In some cases, various authentication parameters may be defined within the policy so that a client, user, or server may be authenticated before a virtual application may be received and executed.

The parameters in block 410 may be any type of parameter or option that may define how a virtual application is to be obtained and any communication parameters used to communicate with a virtual application server. The parameters may also include functional limitations or options for the virtual application itself, along with parameters regarding how the virtual application may be executed on the client device.

The policy may be assigned to specific users in block 412 and to specific devices in block 414. In some embodiments, a policy may be defined only for a device without regard to which user operates the device. In other embodiments, a user may be assigned a set of virtual applications across several different devices.

The policy may be packaged for distribution in block 416. Various embodiments may use different mechanisms to define a policy. For example, some policies may be in XML as a text file that is human readable. Other policies may be defined in a binary data format that is machine readable but not human readable. Some embodiments may package a policy using a messaging system and messaging protocols.

In some such cases, a policy may be encrypted using a private key of a public key/private key encryption system. Such an encryption may serve as a digital signature that the policy is authentic. In some cases, the policy may be encrypted using a public key of a public key/private key encryption system assigned to the recipient of the policy. Such an encryption may serve to enable only the designated recipient to open and implement the policy.

The policy may be distributed to clients in block 418 and to virtual application servers in block 420. In some embodiments, a client version of a policy and a server version of a policy may be distributed. In such a case, the two policies may enable both the client and server to verify or authenticate that the virtual application is permitted to be executed to the client. Such embodiments may be preferred in cases where a client and server are separated by the Internet or some other wide area network where the threat of interlopers may be present. In a more controlled network, such as a local area network, a policy may be used at either the client or server to define which virtual applications are allowed in each circumstance.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a first policy comprising at least one reference to a first virtual application;
making said first virtual application available based on said first policy;
receiving a request for said first virtual application;
causing at least a portion of said first virtual application to be passed over a network; and
causing said at least a portion of said first virtual application to be executed in a virtual manner.

2. The method of claim 1, said policy being received by a client device.

3. The method of claim 1, said policy being received by a virtual application server.

4. The method of claim 1 further comprising:
receiving a second policy, said second policy not containing a reference to said first virtual application; and
making said virtual application unavailable.

5. The method of claim 4, said virtual application being made unavailable by removing a reference to said virtual application from a user interface.

6. The method of claim 1, said virtual application being made available by either adding an icon to a user interface or adding an entry to a menu.

7. The method of claim 1, said receiving at least a portion of said first virtual application comprising storing said first virtual application on a local storage mechanism.

8. The method of claim 1, said policy being applied to predefined devices.

9. The method of claim 1, said policy being applied to predefined users.

10. The method of claim 1, said policy being received by a pull-type mechanism.

11. A client device comprising:
a policy retriever configured to retrieve a first policy from a management server and store said first policy in a policy store, said first policy comprising at least one reference to a first virtual application;
a user interface;
a policy implementer configured to modify said user interface based on said first policy and make said first virtual application available through said user interface;
a virtual server connector configured to connect to a virtual application server and retrieve at least a portion of said first virtual application; and
a virtual application executor configured to execute said first virtual application in a virtual manner.

12. The client device of claim 11, said first policy further comprising:
a set of configuration parameters for said first virtual application.

13. The client device of claim 12, said configuration parameters comprising:
a designator for executing said first virtual application locally or in a streaming manner.

14. The client device of claim 11, said policy implementer further configured to:
modify said user interface based on said first policy to make a second virtual application unavailable, said second virtual application being not referenced in said first policy.

15. The client device of claim 11, said policy retriever further configured to poll said management server to determine if a new policy is available.

16. A server device comprising:
an administrative user interface;
a database comprising at least one virtual application and at least one address for a server for said at least one virtual application;
a policy generator configured to create a policy comprising a reference to said at least one virtual application; and
a policy distributor configured to distribute said policy to a client device.

17. The server device of claim 16, said policy further comprising a user designator for said at least one virtual application.

18. The server device of claim 16, said policy generator being further configured to create a server policy, and said policy distributor being further configured to distribute said server policy to said server for said at least one virtual application.

19. The server device of claim 16, said policy distributor being further configured to push said policy to said client device.

20. The server device of claim 16, said policy distributor being further configured to have said policy pulled by said client device.
